(19) United States
(12) Patent Application Publication
(10) Pub. No.: US 2025/0365574 A1
(43) Pub. Date: Nov. 27, 2025

(54) Security for Sidelink (SL) UE-to-UE Relay

(71) Applicant: Telefonaktiebolaget LM Ericsson (publ), Stockholm (SE)

(72) Inventors: Cheng Wang, Shanghai (CN); Monica Wifvesson, Lund (SE); Zhang Fu, Stockholm (SE)

(21) Appl. No.: 19/109,009

(22) PCT Filed: Sep. 18, 2023
(86) PCT No.: PCT/EP2023/075656

§ 371 Date: Mar. 5, 2025

(30) Foreign Application Priority Data
Sep. 30, 2022 (WO) PCT/CN2022/123479

(51) Int. Cl. H04W 12/0471; H04W 12/041; H04W 12/08; H04W 12/30

(52) U.S. Cl. CPC H04W 12/0471; H04W 12/041; H04W 12/08; H04W 12/30

(57) ABSTRACT

Embodiments include methods for a user equipment (UE) configured to operate as a relay UE for sidelink (SL) communication between a source UE and a target UE. Such methods include identifying the target UE based on a SL discovery procedure performed by the UE or by the target UE, and sending to the target UE a first message that includes a relay service code (RSC) indicating a UE-to-UE relay service provided by the UE. Such methods include obtaining one or more security keys based on a security identifier associated with the target UE. Such methods include establishing a secure link with the target UE based on the obtained one or more security keys. Other embodiments include complementary methods for the target UE, as well as UEs configured to perform such methods.

### TECHNICAL FIELD

The present disclosure relates generally to wireless networks and devices, and more specifically to user equipment (UE) that can communicate with other UEs directly rather than (or in addition to) indirectly via a wireless network.

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is divided into multiple slots of equal duration, with each slot including multiple OFDM-based symbols. Even so, time-frequency resources can be configured much more flexibly for an NR cell than for an LTE cell.

Sidelink (SL) is a type of device-to-device (D2D) communication whereby UEs communicate with each other directly rather than indirectly via a 3GPP RAN. The first 3GPP standardization of SL was in LTE Rel-12 targeting public safety use cases and proximity-based services (ProSe). Since then, several enhancements have been introduced to broaden the use cases that could benefit from D2D technology. For example, the D2D extensions in LTE Rel-14 and Rel-15 include supporting vehicle-to-everything (V2X) communication.

3GPP Rel-16 specifies the NR SL interface. NR Rel-16 SL targets advanced V2X services, which can be categorized into four use case groups: vehicles platooning, extended sensors, advanced driving, and remote driving. The advanced V2X services require a new SL to meet the stringent requirements in terms of latency and reliability. The NR SL is designed to provide higher system capacity and better coverage, and to allow for extension to support the future development of even more advanced V2X services and other related services.

Broadcast, groupcast, and unicast transmissions are desirable for the services targeted by NR SL. In groupcast (or multicast), the intended receiver of a message consists of only a subset of the possible recipients in proximity to the transmitter, whereas a unicast message is intended for only one recipient in proximity to the transmitter. For example, in the platooning service there are certain messages that are only of interest of the members of the platoon, for which groupcast can be used. Unicast is a natural fit for use cases involving only a pair of vehicles.

3GPP Rel-17 includes a work item for coverage extension for SL-based communication, including UE-to-network relay for cellular coverage extension and UE-to-UE relay for SL coverage extension. Additionally, improving performance of power-limited UEs (e.g., pedestrian UEs, first responder UEs, etc.) and improving the performance using resource coordination are also important goals for the Rel-17 work.

Two UE-based relay capabilities were studied for NR SL in Rel-17: UE-to-Network (U2N) relay, where a UE extends the network connectivity to another nearby UE by using direct communication; and UE-to-UE (U2U) relay, where a UE uses two direct communication links to connect two UEs in its proximity that otherwise are not able to communicate.

LTE U2N relay functionality uses a Layer 3 (L3) architecture in which the relay of data packets via the PC5 interface is performed at the network layer, and UEs connected to a L3 U2N relay are transparent to the network. NR SL U2N relay uses two different architectures: a L3 architecture similar to LTE, and a newly defined architecture in which relaying over PC5 interface occurs within Layer 2 (L2), specifically in the RLC sublayer.

3GPP TR 23.752 (v2.0.0) section 6.10 describes ProSe 5G UE-to-UE (U2U) Relay. A ProSe 5G UE-to-UE relay is a (5G ProSe-enabled) UE that provides functionality to support connectivity between 5G ProSe U2U UEs. For UE-to-UE relay use cases, the source UE, the target UE, and the UE-to-UE relay may be in or out of 3GPP coverage. 3GPP TR 33.740 (v0.2.0) describes a security solution for PC5 links between source UE, UE-to-UE relay, and target UE when the UE-to-UE relay is in 3GPP coverage.

### SUMMARY

This study work assumes that the source UE initiates the PC5 link setup with U2U Relay, which initiates the PC5 link setup with the target UE. In other words, PC5 link setup between target UE and relay UE is not done in parallel or concurrent with the PC5 link setup between source UE and relay UE. 3GPP TR 33.740 (v0.2.0) describes a security solution (called “solution 3”) based on the assumption that PC5 link setup between target UE and relay UE is same as between source UE and relay UE. However, there are several differences in how the two PC5 links are set up, which can lead to various problems, issues, and/or ambiguities.

An object of embodiments of the present disclosure is to improve security of SL communication between UEs, such as by providing, enabling, and/or facilitating solutions to overcome exemplary problems summarized above and described in more detail below.

Embodiments include exemplary methods (e.g., procedures) for a UE configured to operate as a relay UE for SL communication between a source UE and a target UE.

These exemplary methods include identifying the target UE based on a SL discovery procedure performed by the UE or by the target UE. These exemplary methods also include sending, to the target UE, a first message that includes a relay service code (RSC) indicating a UE-to-UE relay service provided by the UE. These exemplary methods also include obtaining one or more security keys based on a security identifier associated with the target UE. These exemplary methods also include establishing a secure link with the target UE based on the obtained one or more security keys

In some embodiments, identifying the target UE is responsive to establishing a secure link with the source UE. In some embodiments, the security identifier (i.e., associated with the UE or the target UE) is one of the following: a Subscription Concealed Identifier (SUCI), or a ProSe Remote User Key identifier (PRUK ID).

In some embodiments, these exemplary methods can also include receiving, from the target UE in response to the first message, a second message that includes the security identifier associated with the target UE. In some of these embodiments, the first message also includes address or identifier information for one or more of the following: the source UE, the target UE, and the UE. In some of these embodiments, the first message is a direct communication invite and the second message is a direct communication request.

In some embodiments, identifying the target UE based on the SL discovery procedure includes obtaining indications of one or more of the following from the target UE during the SL discovery procedure:
whether the target UE supports network-based relay service authentication and authorization over the target UE's connection with its serving network;
whether the target UE supports network-based relay service authentication and authorization over the relay UE's connection with its serving network;
whether the target UE supports peer UE-to-peer UE service authentication and authorization; and
whether the target UE is in coverage of a network.

In some of these embodiments, obtaining one or more security keys based on a security identifier associated with the target UE is responsive to obtaining an indication that the target UE supports network-based relay service authentication and authorization over the relay UE's connection with its serving network.

Other embodiments include exemplary methods (e.g., procedures) for a UE configured to operate as a target UE for SL communication with a source UE via a relay UE. In general, these exemplary methods are complementary to the exemplary methods summarized above.

These exemplary methods include identifying the relay UE based on a SL discovery procedure performed by the UE or by the relay UE. These exemplary methods also include receiving, from the relay UE, a first message that includes an RSC indicating a UE-to-UE relay service provided by the relay UE. These exemplary methods also include obtaining one or more security keys based on a security identifier associated with the UE. These exemplary methods also include establishing a secure link with the relay UE based on the obtained one or more security keys

In some embodiments, the SL discovery procedure is performed by the relay UE after the relay UE establishes a secure link with the source UE. In some embodiments, the security identifier is a SUCI or a PRUK ID.

In some of these embodiments, these exemplary methods can also include sending, to the relay UE in response to the first message, a second message that includes the security identifier associated with the UE. In some of these embodiments, the first message also includes address or identifier information for one or more of the following: the source UE, the UE, and the relay UE. In some of these embodiments, the first message is a direct communication invite and the second message is a direct communication request.

In some embodiments, identifying the relay UE based on the SL discovery procedure includes providing indications of one or more of the following to the relay UE during the SL discovery procedure:
whether the target UE supports network-based relay service authentication and authorization over the target UE's connection with its serving network;
whether the target UE supports network-based relay service authentication and authorization over the relay UE's connection with its serving network;
whether the target UE supports peer UE-to-peer UE service authentication and authorization; and
whether the target UE is in coverage of a network.

In some of these embodiments, obtaining one or more security keys based on a security identifier associated with the UE is responsive to providing an indication that the UE supports network-based relay service authentication and authorization over the relay UE's connection with its serving network.

Other embodiments include UEs (e.g., wireless devices) configured to perform operations corresponding to any of the exemplary methods described herein. Other embodiments include non-transitory, computer-readable media storing program instructions that, when executed by processing circuitry, configure such UEs to perform operations corresponding to any of the exemplary methods described herein.

These and other embodiments described herein can facilitate establishment of security on PC5 links without ambiguity, which facilitates end-to-end SL security between a source UE and a target UE via UE-to-UE relay. Thus, secure communications are possible between source and target UEs that are out of network coverage but can communicate with a common relay UE.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows exemplary 5G/NR user plane (UP) and control plane (CP) protocol stacks.

FIG. 2 shows an exemplary 5G/NR network architecture.

FIG. 3 shows exemplary interfaces between two V2X UEs, a RAN, and other network functions.

FIG. 4 shows three exemplary network coverage scenarios for two UEs and a gNB serving a cell.

FIG. 5 shows a reference architecture for 5G ProSe U2N relay.

FIGS. 6-7 show signaling diagrams of UP and CP procedures, respectively, for authorization and secure PC5 link establishment for 5G ProSe U2N Relay.

FIGS. 8-9 show signaling diagrams for high-level procedures for PC5 link security between a source UE, a target UE, a UE-to-UE relay, and a 5GC network.

FIGS. 10-11 show signaling diagrams for security procedures between a target UE, a UE-to-UE relay, and a 5GC network, according to various embodiments of the present disclosure

FIG. 12 shows a flow diagram of an exemplary method for a relay UE (e.g., wireless device), according to various embodiments of the present disclosure.

FIG. 13 shows a flow diagram of an exemplary method for a target UE (e.g., wireless device), according to various embodiments of the present disclosure.

FIG. 14 shows a communication system according to various embodiments of the present disclosure.

FIG. 15 shows a UE according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is often used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

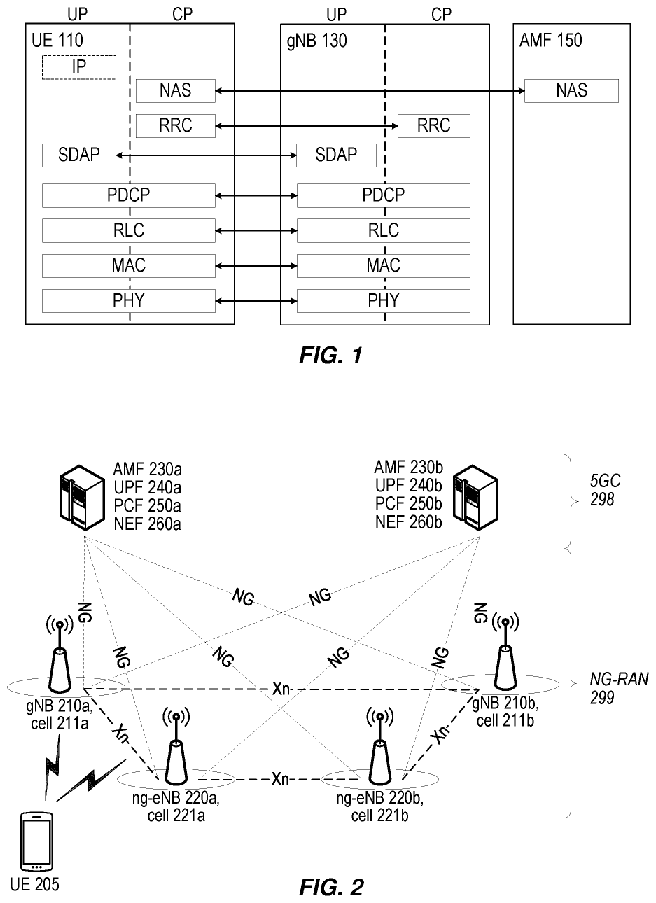

FIG. 1 shows an exemplary configuration of NR user plane (UP) and control plane (CP) protocol stacks between a UE (110), a gNodeB (gNB, e.g., base station, 120), and an access and mobility management function (AMF, 130) in a 5G core network (5GC). Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UB will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on physical DL control channel (PDCCH) for pages from 5GC via gNB. A UE in RRC_IDLE state is not known to the gNB serving the cell where the UE is camping. However, NR RRC includes an RRC_INACTIVE state in which a UE is known (e.g., via context) by the serving gNB.

FIG. 2 shows a high-level view of an exemplary 5G network architecture, including a Next Generation Radio Access Network (NG-RAN, 299) and a 5GC (298). As shown in the figure, the NG-RAN can include gNBs (e.g., 210a,b) and ng-eNBs (e.g., 220a,b) that are connected via respective Xn interfaces. The gNBs and ng-eNBs are also connected to the 5GC via the NG interfaces, more specifically to access and mobility management function (AMFs, e.g., 230a,b) via respective NG-C interfaces and to user plane functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. In contrast, each of ng-eNBs can support the LTE radio interface but, unlike conventional LTE eNodeBs (eNBs), connect to the 5GC via the NG interface. Each of the gNBs and ng-eNBs can serve a geographic coverage area including one more cells (e.g., 211a-b, 221a-b). The gNBs and ng-eNBs can also use various directional beams to provide coverage in the respective cells. Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

Each gNB can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. A CU connects to its associated DUs over respective F1 logical interfaces. Each of the CUs and DUs can include various circuitry needed to perform their respective functions, including processing circuitry, communication interface circuitry (e.g., for communication via Xn, NG, radio, etc. interfaces), and power supply circuitry.

As briefly mentioned above, 3GPP Rel-16 specifies the NR sidelink (SL) interface and targets advanced V2X services including use cases such as vehicles platooning, extended sensors, advanced driving, and remote driving. The advanced V2X services require a new SL to meet service requirements of low latency and high reliability. The NR SL is designed to provide higher system capacity and better coverage, and to allow for extension to support the future development of even more advanced V2X services and other related services.

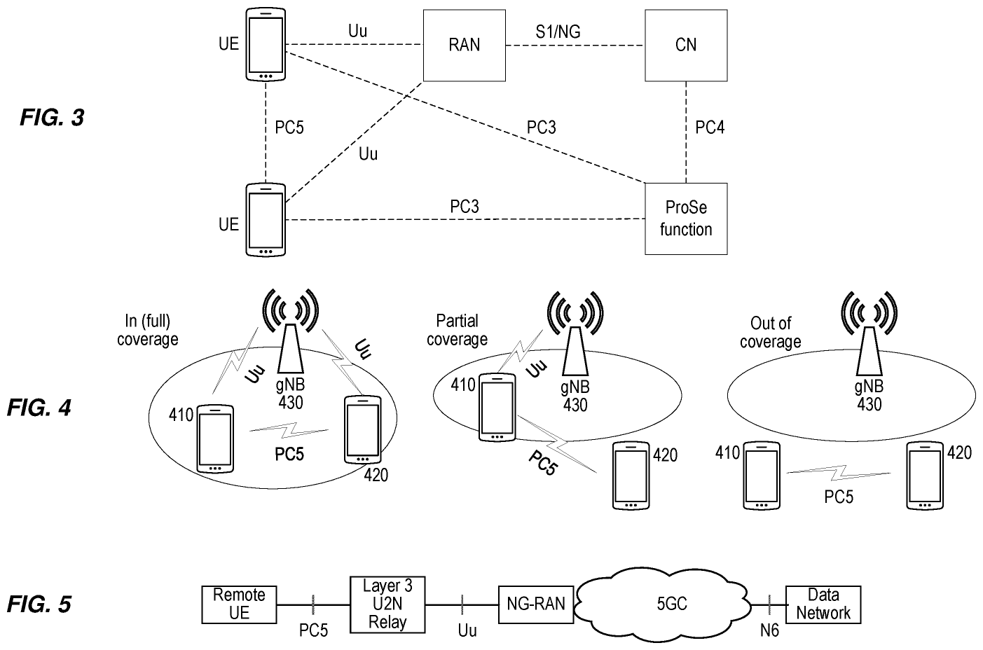

In general, a V2X UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface. FIG. 3 shows an exemplary arrangement of interfaces between two V2X UEs and a RAN. In addition to Uu and PC5 interfaces, the V2X UEs can communicate with a ProSe (PROximity-based SErvices) network function (NF) via respective PC3 interfaces. Communication with the ProSe NF requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

FIG. 4 shows three exemplary network coverage scenarios for two UEs (410, 420) and a gNB (430) serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In general, the term “SL standalone” refers to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured by the network (e.g., gNB) via RRC signaling and/or broadcast system information, either directly (via Uu interface) or indirectly (via PC5 interface and relay UE Uu interface). Out-of-coverage UEs rely on a (pre-) configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

3GPP Rel-17 includes a work item for coverage extension for SL-based communication, including UE-to-network relay for cellular coverage extension and UE-to-UE relay for SL coverage extension. Additionally, improving performance of power-limited UEs (e.g., pedestrian UEs, first responder UEs, etc.) and improving the performance using resource coordination are also important goals for the Rel-17 work.

Two UE-based relay capabilities were studied for NR SL in Rel-17: UE-to-Network (U2N) relay, where a UE extends the network connectivity to another nearby UE by using direct communication; and UE-to-UE (U2U) relay, where a UE uses two direct communication links to connect two UEs in its proximity that otherwise are not able to communicate. U2N relay functionality is fundamental for network coverage extension for public safety in remote areas, for wearable devices tethering in commercial use cases (e.g., sensors, virtual reality headsets), etc. U2U relay functionality was not part of the LTE ProSe specification, and its inclusion on NR ProSe can be beneficial for public safety communications range extension for both in-network and off-network use cases.

LTE U2N relay functionality uses a Layer 3 (L3) architecture in which the relay of data packets via the PC5 interface is performed at the network layer, and UEs connected to a L3 U2N relay are transparent to the network. NR SL U2N relay uses two different architectures: a L3 architecture similar to LTE, and a newly defined architecture in which PC5 relaying occurs within Layer 2 (L2), over the RLC sublayer.

3GPP TR 23.752 (v2.0.0) section 6.7 describes L2-based U2N relay functionality, which includes forwarding functionality that can relay any type of traffic over the PC5 interface between two UEs. A L2 U2N Relay UE supports connectivity to the 5GS (i.e., NG-RAN and 5GC) for other UEs that have successfully established a PC5 link to the L2 U2N Relay UE. A UE connected to a L2 U2N relay will be seen by the network as a regular UE., as if it was directly connected to the network. This gives the network control of the connection and services, but requires the definition of several new mechanisms not present or needed in the L3 architecture.

3GPP TR 23.752 (v2.0.0) section 6.6 describes L3-based U2N relay functionality (also referred to as “ProSe 5G U2N Relay”) that can be used for both public safety and commercial services. A ProSe 5G U2N Relay UE supports connectivity to the 5GS (i.e., NG-RAN and 5GC) for other UEs that have successfully established a PC5 link to the ProSe 5G U2N Relay UE. FIG. 5 shows a reference architecture for 5G ProSe U2N relay.

3GPP TS 33.503 (v17.1.0) defines security procedures for 5G ProSe Communication via 5G ProSe L3 U2N Relay, specifically user-plane (UP) based and control-plane (CP) procedures. Both can be used for 5G ProSe U2N Relay authorization and security establishment via PC5 interface.

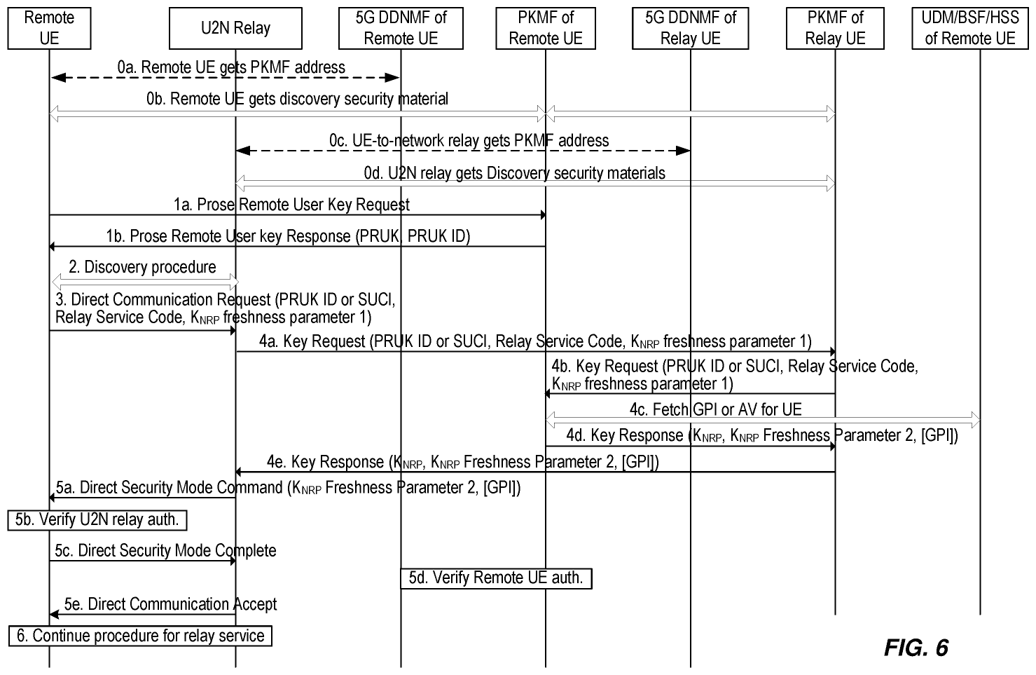

FIG. 6 shows a signaling diagram of the UP procedure for authorization and secure PC5 link establishment for 5G ProSe U2N Relay. The UP procedure uses a UP connection to the 5G ProSe Key Management Function (PKMF) in the 5GC. The 5G ProSe Remote UE is provisioned with the discovery security materials and Prose Remote User Key (UP-PRUK) when it is in coverage. These security materials are associated with an expiration time, after which they become invalid. If the UE does not have valid discovery security materials, the 5G ProSe Remote UE needs to connect to the 5G PKMF and obtain fresh ones to use the 5G ProSe UE-to-Network Relay services. The operations of the procedure shown in FIG. 6 are described in detail in 3GPP TS 33.503 (v17.1.0) section 6.3.3.2.2.

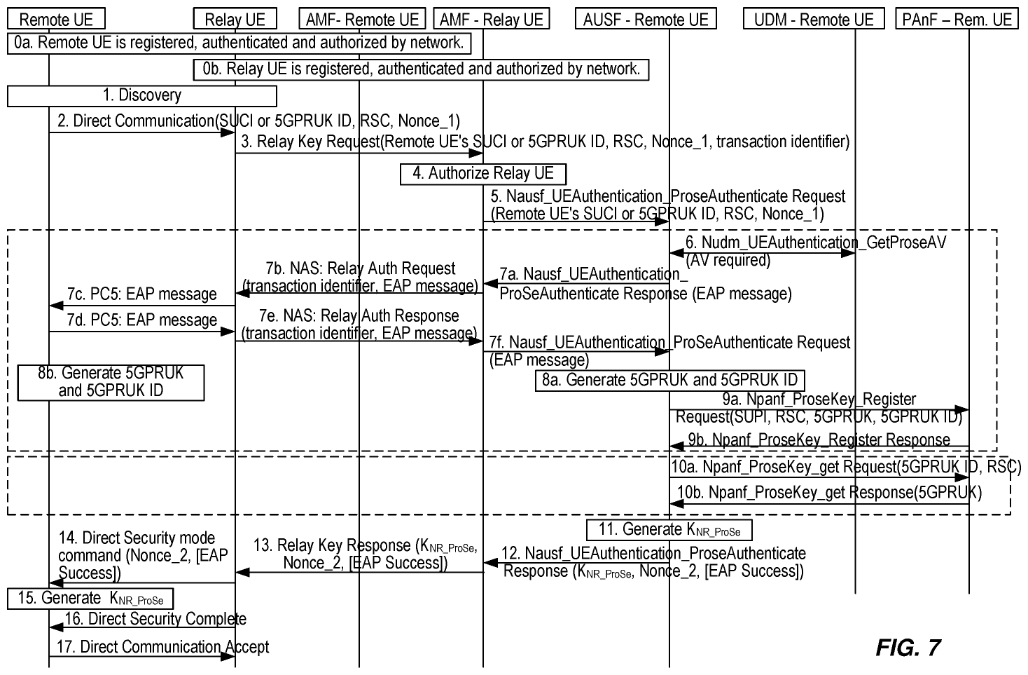

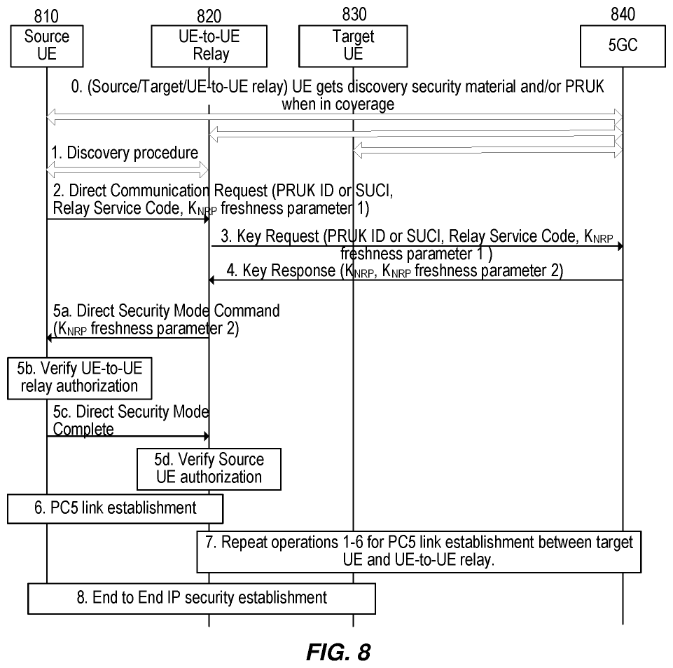

FIG. 7 shows a signaling diagram of the CP procedure for authorization and secure PC5 link establishment for 5G ProSe U2N Relay. The CP procedure uses the ProSe authentication vehicle over NAS procedure towards AMF and authentication server function (AUSF) in the 5GC. The procedure includes the 5G ProSe Remote UE being authenticated by the AUSF of the 5G ProSe Remote UE via the 5G ProSe UE-to-Network Relay and the AMF of the 5G ProSe UE-to-Network Relay during 5G ProSe PC5 establishment. This mechanism can be used when the 5G ProSe Remote UE is out of coverage. The operations of the procedure show in FIG. 7 are described in detail in 3GPP TS 33.503 (v17.1.0) section 6.3.3.2.3.

3GPP TR 23.752 (v2.0.0) section 6.10 describes ProSe 5G UE-to-UE (U2U) Relay. A ProSe 5G UE-to-UE relay is a (5G ProSe-enabled) UE that provides functionality to support L3 connectivity between 5G ProSe U2U UEs. For UE-to-UE relay use cases, the source UE, the target UE, and the UE-to-UE relay may be in or out of 3GPP coverage. Note that terms “UE-to-UE relay” and “relay UE” are used interchangeably herein. 3GPP TR 33.740 (v0.2.0) describes a security solution for PC5 links between source UE, UE-to-UE relay, and target UE when the UE-to-UE relay is in 3GPP coverage. This solution is referred to as “solution #3” and addresses two key issues: Security of UE-to-UE relay and authorization in the UE-to-UE relay Scenario. This solution assumes that PKMF and 5G Direct Discovery Name Management Function (5GDDNMF) are deployed in the 5GC of the network.

FIG. 8 shows a signaling diagram for a high-level procedure of PC5 link security between a source UE (810), target UE (830), UE-to-UE relay (820), and 5GC (840), according to solution #3, as further described in 3GPP TR 33.740 (v0.2.0) section 6.3.2. Although the operations in FIG. 8 are given numerical labels, this is intended to facilitate explanation rather than to require or imply any specific operational order, unless expressly stated otherwise.

In operation 0, which can be considered a prerequisite, the source/target UE and UE-to-UE relay are provisioned with the discovery security materials and/or PRUK when they are in coverage. In operation 1, the discovery procedure for UE-to-UE relay is performed by the source UE using the discovery parameters and discovery security material, based on the Relay Service Code for UE-to-UE relay. If the UE-to-UE relay is in 3GPP coverage, it also indicates whether network-based Relay service authentication and authorization is supported for UE-to-UE relay in the discovery announcement message.

In operation 2, if the discovered UE-to-UE relay supports network-based Relay service authentication and authorization, the source UE sends a Direct Communication Request (DCR) that contains PRUK ID or SUCI, Relay Service Code (RSC) of the UE-to-UE relay service and KNRP freshness parameter 1 to the UE-to-UE relay.

In operation 3, the UE-to-UE relay sends a Key Request message that contains PRUK ID or SUCI, RSC and KNRP freshness parameter 1 to the 5GC. Note that detailed descriptions of 5GC NFs and internal signalling are omitted for brevity. The similar security procedure as Security for 5G ProSe Communication via 5G ProSe Layer-3 UE-to-Network Relay as defined in 3GPP TS 33.503 (v17.1.0) can be reused. In operation 4, the 5GC sends the Key Response message to the UE-to-UE relay, which includes KNRP, KNRP freshness parameter 2.

In operation 5a, the UE-to-UE relay derives the session key (KNRP-SESS) from KNRP and then derives the confidentiality key (NRPEK) (if applicable) and integrity key (NRPIK) based on the PC5 security policies as specified in 3GPP TS 33.536 (v17.1.0). The UE-to-UE relay sends a Direct Security Mode Command message to the source UE and include KNRP Freshness Parameter 2 in the message.

In operation 5b, the source UE derives KNRP from its PRUK, RSC, KNRP Freshness Parameter 1 and the received KNRP Freshness Parameter 2 and then derives the session key (KNRP-SESS) and the confidentiality key (NRPEK) (if applicable) and integrity key (NRPIK) based on the PC5 security policies in the same manner as the UE-to-UE relay and processes the Direct Security Mode Command. Successful verification of the Direct Security Mode Command assures the source UE that the UE-to-UE relay is authorized to provide the UE-to-UE relay service.

In operation 5c, the source UE responds with a Direct Security Mode Complete message to the UE-to-UE relay. In operation 5d, upon receiving the Direct Security Mode Complete message, the UE-to-UE relay shall verify the Direct Security Mode Complete message. Successful verification of the Direct Security Mode Complete message assures the UE-to-UE relay that the source UE is authorized to get the UE-to-UE relay service.

In operation 6, the source UE and UE-to-UE relay continue the procedure for the UE-to-UE relay service over the secure PC5 link. In operation 7, operations 1-6 described above are repeated for PC5 security establishment between the target UE and UE-to-UE relay. PC5 security set up procedure between target UE and the UE-to-UE relay (operation 7) may be performed in parallel to the PC5 security set up procedure between source UE and UE-to-UE relay (operations 1-6). Note that it is for further study how the target UE determines whether this PC5 link is used for direct communication with the UE-to-UE relay or for U2U communication with the source UE.

In operation 8, the source UE and the target UE may establish an end-to-end Security via the UE-to-UE relay. 3GPP TR 33.740 (v0.2.0) does not provide details for how this operation is performed.

3GPP TR 33.740 (v0.2.0) also describes a solution for security of PC5 links between source UE, target UE, and L3 UE-to-UE relay based on Peer UE-to-Peer UE security, when the UEs are out of 3GPP coverage. This solution is referred to as “solution #4” and addresses two key issues: 1) security of UE-to-UE relay, and 2) authorization in the UE-to-UE relay scenario. This solution assumes long term credentials are provisioned into the UE(s) and form the root of the security of the PC5 unicast link as specified in 3GPP TS 33.536 (v17.1.0).

Solution #4 uses authorization tokens as in OAuth 2.0 (specified in IETF RFC 6749) to indicate that a source UE, a target UE, or a L3 UE-to-UE relay is authorized to use or to serve a specific UE-to-UE service. When the source UE, the target UE, or the L3 UE-to-UE relay registers in the 3GPP network and is authorized to use the UE-to-UE service, the network provides a token stating what kind of UE-to-UE service it can use or serve. The token has an expiration time and is signed with a private key. The network also provides the public key to the UEs to be used for verifying the token from other parties.

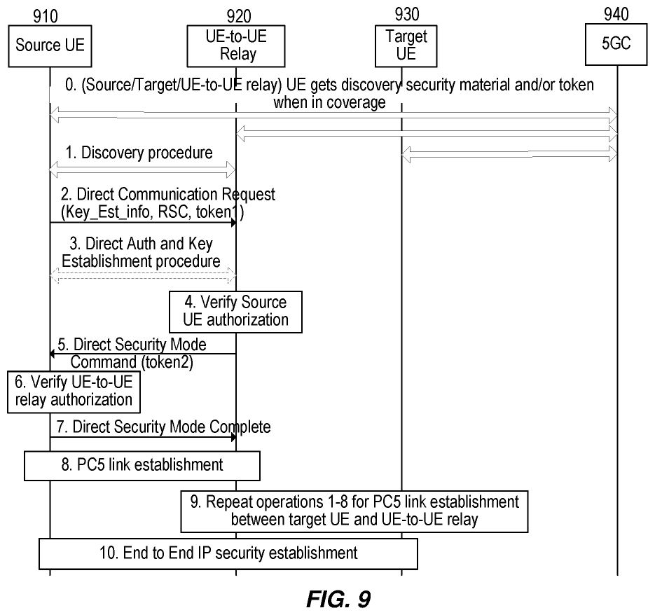

FIG. 9 shows a signaling diagram for a high-level procedure for PC5 security between source UE (910), target UE (930), UE-to-UE relay (920), and 5GC (940) according to solution #4, as further described in 3GPP TR 33.740 (v0.2.0) section 6.4.2. Although the operations in FIG. 9 are given numerical labels, this is intended to facilitate explanation rather than to require or imply any specific operational order, unless expressly stated otherwise.

In operation 0, which can be considered a prerequisite, the source UE, target UE, and UE-to-UE relay are provisioned with the discovery security materials and request authorization tokens when they are in coverage. For example, the discovery security materials can include a discovery security key associated with a Relay Service Code (RSC) for UE-to-UE relay. In operation 1, the discovery procedure for UE-to-UE relay is performed by the source UE using the discovery parameters and discovery security material, based on the RSC for UE-to-UE relay.

In operation 2, if discovery result from operation 1 indicates the UE-to-UE relay supports Direct Relay service authentication and authorization, the source UE sends a Direct Communication Request (DCR) that contains Relay Service Code (RSC) of the UE-to-UE relay service and Authorization token of 5G ProSe source UE which is retrieved from operation 0, and also the Key_Est_Info used for direct authentication and key establishment.

In operation 3, Direct Auth and Key Establish procedure is performed as specified in 3GPP TS 33.536 (v17.1.0). In operation 4, the UE-to-UE relay uses the public key provided by the network to verify the authorization token of the source UE, i.e., that the source UE is authorized to get the UE-to-UE relay service.

In operation 5, the UE-to-UE relay derives KNRP and other security material as specified in 3GPP TS 33.536 (v17.1.0). The UE-to-UE relay sends a Direct Security Mode Command message to the source UE including the authorization token of UE-to-UE relay which is retrieved from operation 0. In operation 6, the source UE uses the public key provided by the network to verify the authorization token of the UE-to-UE relay, i.e., that the UE-to-UE relay is authorized to provide the UE-to-UE relay service. The source UE derives KNRP and other security material in an analogous manner as the UE-to-UE relay in operation 5.

In operation 7, the source UE sends the Direct Security Mode Complete message to the UE-to-UE. In operation 8, the source UE and 5G ProSe UE-to-UE relay continue with the rest of procedure for the UE-to-UE relay service over the secure PC5 link.

In operation 9, operations 1-8 described above are repeated for PC5 security establishment between the target UE and UE-to-UE relay. It is currently unclear whether the PC5 security set up procedure between target UE and UE-to-UE relay (operation 9) can be performed after or in parallel with the PC5 security set up procedure between source UE and UE-to-UE relay (operations 1-8). It is also currently unclear how the target UE determines whether this PC5 link is used for direct communication with the UE-to-UE relay or for U2U communication with source UE. In operation 10, the source UE and the target UE may establish an end-to-end Security via UE-to-UE relay.

Various aspects of solution #4 shown in FIG. 9 are not specified and require further study, including the method for providing End to End IP security, the need of End-to-end security in L3 relay, and the impact on the protocol stack to support end-to-end security for a L3 relay.

The security procedures described above assume that that source UE initiates the PC5 link setup with the UE-to-UE relay, which initiates the PC5 link setup with the target UE. In other words, PC5 link setup between target UE and relay UE is not in parallel or concurrent with the PC5 link setup between source UE and relay UE, since the relay UE triggers PC5 link setup with target UE. Even so, solution 3 described above (e.g., operation 7 in FIG. 8) is based on the implicit assumption that PC5 link setup between target UE and Relay UE is same as PC5 link setup between source UE and relay UE. However, there are differences between setup of these two PC5 links.

For example, when the source UE triggers PC5 link setup (“first hop”) with the relay UE assumed to be in 3GPP network coverage, the security procedure is performed over the connection the relay UE established with the 3GPP network (via a network-based security establishment procedure). In contrast, when the relay UE triggers PC5 link setup (“second hop”) with the target UE, it is unclear whether the target UE is in 3GPP network coverage. Thus, it is unknown whether the security procedure for the second hop will be performed over a connection the relay UE established with the 3GPP network or over a connection that the target UE established with its serving 3GPP network (if any). Furthermore, it is unknown whether a network based security establishment procedure or a peer-to-peer security establishment procedure (i.e., not relying on UE connectivity with a serving network) will be used. These ambiguities can cause various problems, issues, and/or difficulties in the security procedure.

Embodiments of the present disclosure provide flexible and efficient security establishment procedures for a relay UE to use when attempting to establish a PC5 link with a target UE. In various embodiments, the relay UE can:
perform a network-based security establishment procedure over a connection that the relay UE established with its serving 3GPP network;
perform a network-based security establishment procedure over a connection that the target UE established with its serving 3GPP network.; or
perform peer UE-to-peer UE security establishment with the target UE, which does not rely on a connection of either UE with a serving 3GPP network (e.g., as in 3GPP TR 33.740 solution #4 discussed above).
   Embodiments also include techniques whereby a relay UE can discover whether the target UE supports these various security establishment procedures.

In this manner, embodiments facilitate establishment of security on PC5 links without ambiguity, which facilitates end-to-end SL security between a source UE and a target UE via UE-to-UE relay. Thus, secure communications are possible between source and target UEs that are out of network coverage but can communicate with a common relay UE.

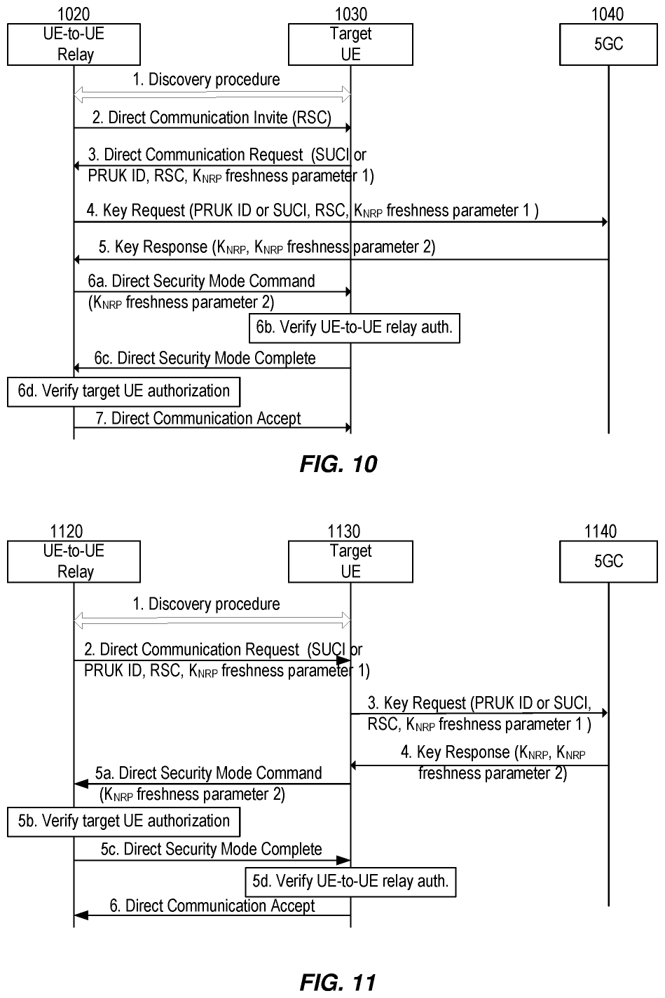

FIG. 10 shows a signaling diagram for a security procedure between a target UE (1030), UE-to-UE relay (1020), and a 5GC (1040), according to some embodiments of the present disclosure. The operations shown in FIG. 10 may be related to operations by a source UE, which are not shown. For example, the operations shown in FIG. 10 can replace operation 7 of FIG. 8, discussed above and specified in 3GPP TR 33.740 (v0.2.0). Although the operations shown in FIG. 10 are given numerical labels, this is intended to facilitate explanation rather than to require or imply any specific operational order, unless expressly stated otherwise.

Although not shown, the target UE and UE-to-UE relay (also source UE) are provisioned with discovery security materials and/or ProSe Remote User Key (PRUK) when they are in coverage. In operation 1, a discovery procedure is performed between the UE-to-UE relay and the target UE (as peer UE), using the discovery parameters and discovery security material, based on the Relay Service Code (RSC) for UE-to-UE relay.

In operation 2, the UE-to-UE relay sends the target UE a Direct Communication Invite that contains the RSC. In some embodiments, this message may contain UE address information, including address information for one or more of the source UE, the target UE, and the UE-to-UE relay. This address information may be used by the target UE in deciding whether to accept the Direct Communication Invite. Operations 3-7 are the same as FIG. 8 operations 2-6, respectively, except that operations 3-7 involve the target UE instead of the source UE as in FIG. 8 operations 2-6.

FIG. 11 shows a signaling diagram for another security procedure between a target UE (1130), UE-to-UE relay (1120), and a 5GC (1140), according to other embodiments of the present disclosure. The operations shown in FIG. 11 may be related to operations by a source UE, which are not shown. For example, the operations shown in FIG. 11 can replace operation 7 of FIG. 8, discussed above and specified in 3GPP TR 33.740 (v0.2.0). Although the operations shown in FIG. 11 are given numerical labels, this is intended to facilitate explanation rather than to require or imply any specific operational order, unless expressly stated otherwise.

Although not shown, the target UE and UE-to-UE relay (also source UE) are provisioned with discovery security materials and/or ProSe Remote User Key (PRUK) when they are in coverage. In operation 1, a discovery procedure is performed between the UE-to-UE relay and the target UE (as peer UE), using the discovery parameters and discovery security material, based on the Relay Service Code (RSC) for UE-to-UE relay. During the discovery procedure, the target UE can indicate one or more of the following to the UE-to-UE relay:
whether the target UE supports network-based relay service authentication and authorization over the target UE's connection with its serving 3GPP network;
whether the target UE supports network-based relay service authentication and authorization over the relay UE's connection with its serving 3GPP network;
whether the target UE supports peer UE-to-peer UE service authentication and authorization; and.
whether the target UE is in coverage of a 3GPP network.

If the discovered target UE supports network-based relay service authentication and authorization over the relay UE's connection with its serving 3GPP network, then the UE-to-UE relay and the target UE perform operations 2-7 shown in FIG. 10.

If the discovered target UE supports network-based relay service authentication and authorization over the target UE's connection with its serving 3GPP network and the target UE is in 3GPP coverage, then the UE-to-UE relay and the target UE perform operations 2-6 shown in FIG. 8, except that the UE-to-UE relay performs the operations performed by the source UE in FIG. 8 and the target UE performs the operations performed by the UE-to-UE relay in FIG. 8. FIG. 11 illustrates this arrangement.

If the discovered target UE supports peer UE-to-peer UE relay service authentication and authorization, then the UE-to-UE relay and the target UE perform operations 2-8 shown in FIG. 9, which correspond to solution 4 described in 3GPP TR 33.740.

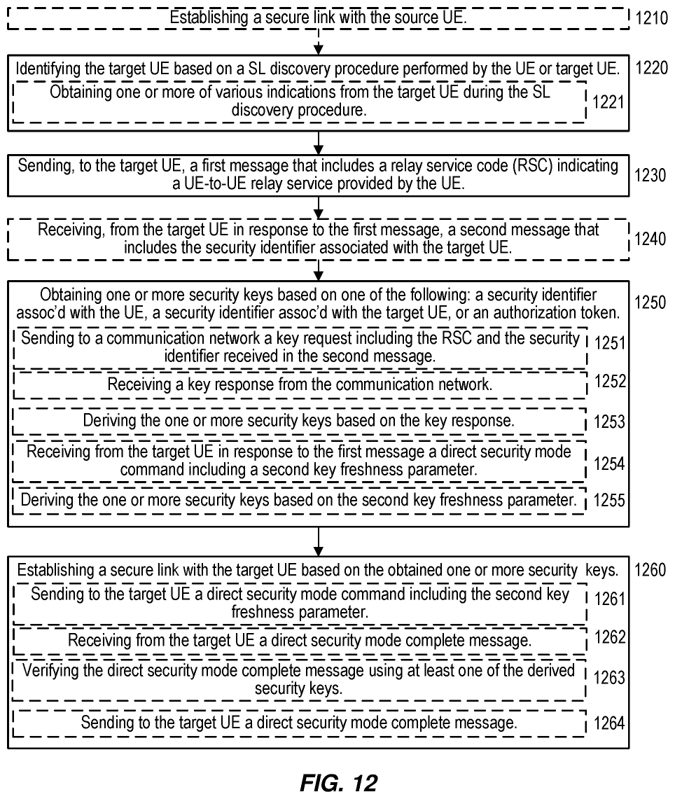

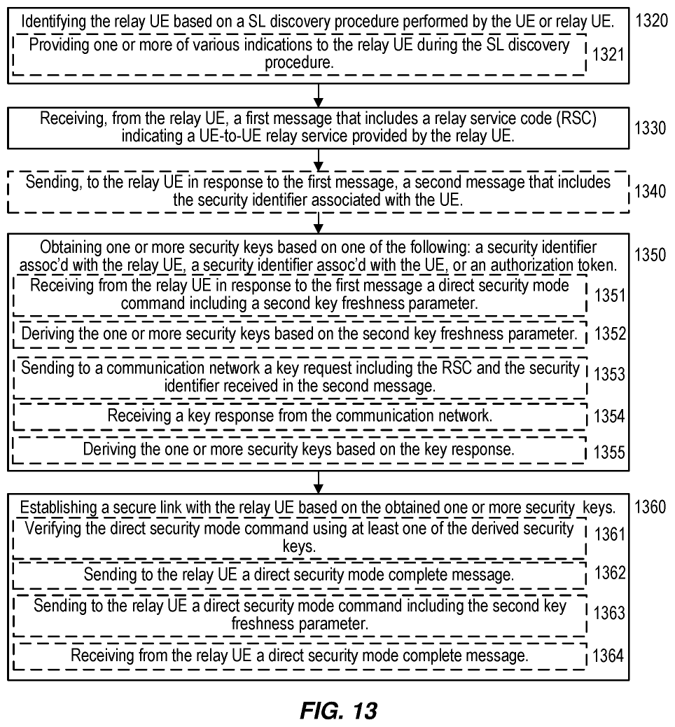

Various features of the embodiments described above correspond to various operations illustrated in FIGS. 12-13, which show exemplary methods (e.g., procedures) for a relay UE and a target UE, respectively. In other words, various features of the operations described below correspond to various embodiments described above. Furthermore, the exemplary methods shown in FIGS. 12-13 can be used cooperatively to provide various benefits, advantages, and/or solutions to problems described herein. Although FIGS. 12-13 show specific blocks in particular orders, the operations of the exemplary methods can be performed in different orders than shown and can be combined and/or divided into blocks having different functionality than shown. Optional blocks or operations are indicated by dashed lines.

In particular, FIG. 12 shows an exemplary method (e.g., procedure) for a UE configured to operate as a relay UE for SL communication between a source UE and a target UE, according to various embodiments of the present disclosure. The exemplary method can be performed by a UE (e.g., wireless device) such as described elsewhere herein.

The exemplary method includes the operations of block 1220, where the UE can identify the target UE based on a SL discovery procedure performed by the UE or by the target UE. The exemplary method also includes the operations of block 1230, where the UE can send, to the target UE, a first message that includes a relay service code (RSC) indicating a UE-to-UE relay service provided by the UE. The exemplary method also includes the operations of block 1250, where the UE can obtain one or more security keys based on one of the following: a security identifier associated with the UE, a security identifier associated with the target UE, or an authorization token. The exemplary method also includes the operations of block 1260, where the UE can establish a secure link with the target UE based on the obtained one or more security keys

In some embodiments, identifying the target UE in block 1220 is responsive to the operations of block 1210, where the UE establishes a secure link with the source UE. In some embodiments, the security identifier (i.e., associated with the UE or the target UE) is one of the following: a Subscription Concealed Identifier (SUCI), or a ProSe Remote User Key identifier (PRUK ID).

In some embodiments, the exemplary method can also include the operations of block 1240, where the UE can receive, from the target UE in response to the first message, a second message that includes the security identifier associated with the target UE. In some of these embodiments, the first message also includes address or identifier information for one or more of the following: the source UE, the target UE, and the UE. In some of these embodiments, the first message is a direct communication invite and the second message is a direct communication request, such as illustrated in FIG. 10.

In some of these embodiments, obtaining one or more security keys in block 1250 includes the following operations, labelled with corresponding sub-block numbers:
(1251) sending to a communication network (e.g., 5GC) a key request including the RSC and the security identifier received in the second message;
(1252) receiving a key response from the communication network; and
(1253) deriving the one or more security keys based on the key response.

In some of these embodiments, the second message and the key request also include a first key freshness parameter, the key response includes a second key freshness parameter, and establishing the secure link with the relay UE in block 1260 includes the following operations, labelled with corresponding sub-block numbers:
(1261) sending to the target UE a direct security mode command including the second key freshness parameter;
(1262) receiving from the target UE a direct security mode complete message; and
(1263) verifying the direct security mode complete message using at least one of the derived security keys.

In some embodiments, identifying the target UE based on the SL discovery procedure in block 1220 includes the operations of sub-block 1221, where the UE can obtain indications of one or more of the following from the target UE during the SL discovery procedure:
whether the target UE supports network-based relay service authentication and authorization over the target UE's connection with its serving network;
whether the target UE supports network-based relay service authentication and authorization over the relay UE's connection with its serving network;
whether the target UE supports peer UE-to-peer UE service authentication and authorization; and
whether the target UE is in coverage of a network.

In some of these embodiments, obtaining one or more security keys based on a security identifier associated with the target UE in block 1250 is responsive to obtaining an indication (e.g., in sub-block 1221) that the target UE supports network-based relay service authentication and authorization over the relay UE's connection with its serving network.

In other embodiments, obtaining one or more security keys based on a security identifier associated with the UE in block 1250 is responsive to obtaining indications (e.g., in sub-block 1221) of one or more the following during the SL discovery procedure:
the target UE does not support network-based relay service authentication and authorization over the relay UE's connection with its serving network;
the target UE supports network-based relay service authentication and authorization over the target UE's connection with its serving network; and
the target UE is in coverage of a network.

In some of these embodiments, the first message is a direct communication request that includes the security identifier associated with the UE and a first key freshness parameter. FIG. 11 shows an example of these embodiments. In such embodiments, obtaining one or more security keys based on a security identifier associated with the UE in block 1250 includes the following operations, labelled with corresponding sub-block numbers:
(1254) receiving from the target UE in response to the first message a direct security mode command including a second key freshness parameter;
(1255) deriving the one or more security keys based on the second key freshness parameter.

In some of these embodiments, deriving the one or more security keys in sub-block 1253 is further based on the RSC and the security key identifier associated with the UE. In some of these embodiments, establishing the secure link in block 1260 includes the following operations, labelled with corresponding sub-block numbers:
(1263) verifying the direct security mode command message using at least one of the derived security keys; and
(1264) sending to the target UE a direct security mode complete message.

In other embodiments, obtaining one or more security keys based on the authorization token in block 1250 is responsive to obtaining during the SL discovery procedure an indication that the target UE supports peer UE-to-peer UE service authentication and authorization. In some of these embodiments, obtaining one or more security keys based on the authorization token is further responsive to obtaining during the SL discovery procedure indications of at least one of the following:
the target UE does not support network-based relay service authentication and authorization over the relay UE's connection with its serving network;
the target UE does not support network-based relay service authentication and authorization over the target UE's connection with its serving network; and
the target UE is not in coverage of a network.

In some of these embodiments, obtaining one or more security keys based on the authorization token in block 1250 includes a Direct Auth and Key Establish procedure performed with the target UE.

In addition, FIG. 13 shows an exemplary method (e.g., procedure) for a UE configured to operate as a target UE for SL communication with a source UE via a relay UE, according to various embodiments of the present disclosure. The exemplary method can be performed by a UE (e.g., wireless device) such as described elsewhere herein.

The exemplary method includes the operations of block 1320, where the UE can identify the relay UE based on a SL discovery procedure performed by the UE or by the relay UE. The exemplary method also includes the operations of block 1330, where the UE can receive, from the relay UE, a first message that includes a relay service code (RSC) indicating a UE-to-UE relay service provided by the relay UE. The exemplary method also includes the operations of block 1350, where the UE can obtain one or more security keys based on one of the following: a security identifier associated with the relay UE, a security identifier associated with the UE, or an authorization token. The exemplary method also includes the operations of block 1360, where the UE can establish a secure link with the relay UE based on the obtained one or more security keys

In some embodiments, the SL discovery procedure is performed by the relay UE after the relay UE establishes a secure link with the source UE. In some embodiments, the security identifier is a SUCI or a PRUK ID.

In some of these embodiments, the exemplary method can also include the operations of block 1340, where the UE can send, to the relay UE in response to the first message, a second message that includes the security identifier associated with the UE. In some of these embodiments, the first message also includes address or identifier information for one or more of the following: the source UE, the UE, and the relay UE. In some of these embodiments, the first message is a direct communication invite and the second message is a direct communication request. FIG. 10 shows an example of these embodiments.

In some of these embodiments, the second message also includes a first key freshness parameter and obtaining one or more security keys based on a security identifier associated with the UE in block 1350 includes the following operations, labelled with corresponding sub-block numbers:
(1351) receiving from the relay UE in response to the first message a direct security mode command including a second key freshness parameter;
(1352) deriving the one or more security keys based on the second key freshness parameter.

In some of these embodiments, deriving the one or more security keys in sub-block 1355 is further based on the RSC and the security key identifier associated with the UE. In some of these embodiments, establishing the secure link with the relay UE in block 1360 includes the following operations, labelled with corresponding sub-block numbers:
(1361) verifying the direct security mode command message using at least one of the derived security keys; and
(1362) sending to the relay UE a direct security mode complete message.

In some embodiments, identifying the relay UE based on the SL discovery procedure in block 1320 includes the operations of sub-block 1321, where the UE can provide indications of one or more of the following to the relay UE during the SL discovery procedure:
whether the target UE supports network-based relay service authentication and authorization over the target UE's connection with its serving network;
whether the target UE supports network-based relay service authentication and authorization over the relay UE's connection with its serving network;
whether the target UE supports peer UE-to-peer UE service authentication and authorization; and
whether the target UE is in coverage of a network.

In some of these embodiments, obtaining one or more security keys based on a security identifier associated with the UE in block 1350 is responsive to providing an indication (e.g., in sub-block 1321) that the UE supports network-based relay service authentication and authorization over the relay UE's connection with its serving network.

In other embodiments, obtaining one or more security keys based on a security identifier associated with the relay UE in block 1350 is responsive to providing indications (e.g., in sub-block 1321) of one or more the following during the SL discovery procedure:
the target UE does not support network-based relay service authentication and authorization over the relay UE's connection with its serving network;
the target UE supports network-based relay service authentication and authorization over the target UE's connection with its serving network; and
the target UE is in coverage of a network.

In some of these embodiments, the first message is a direct communication request that includes the security identifier associated with the relay UE and a first key freshness parameter, and obtaining one or more security keys in block 1350 includes the following operations, labelled with corresponding sub-block numbers:
(1353) sending to a communication network (e.g., 5GC) a key request including the RSC and the security identifier received in the first message;
(1354) receiving a key response from the communication network; and
(1355) deriving the one or more security keys based on the key response.

In some variants of these embodiments, the key response received in sub-block 1352 includes a second key freshness parameter and establishing the secure link in block 1360 includes the following operations, labelled with corresponding sub-block numbers:
(1363) sending to the relay UE a direct security mode command including the second key freshness parameter;
(1364) receiving from the relay UE a direct security mode complete message; and
(1361) verifying the direct security mode complete message using at least one of the derived security keys.
   FIG. 11 shows an example of these embodiments and variants.

In other embodiments, obtaining one or more security keys based on the authorization token in block 1350 is responsive to providing during the SL discovery procedure (e.g., in sub-block 1321) an indication that the UE supports peer UE-to-peer UE service authentication and authorization. In some of these embodiments, obtaining one or more security keys based on the authorization token in block 1350 is further responsive to providing during the SL discovery procedure indications of one or more of the following:
the UE does not support network-based relay service authentication and authorization over the relay UE's connection with its serving network;
the UE does not support network-based relay service authentication and authorization over the UE's connection with its serving network; and
the UE is not in coverage of a network.

In some embodiments, obtaining one or more security keys based on the authorization token in block 1350 includes a Direct Auth and Key Establish procedure performed with the relay UE.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

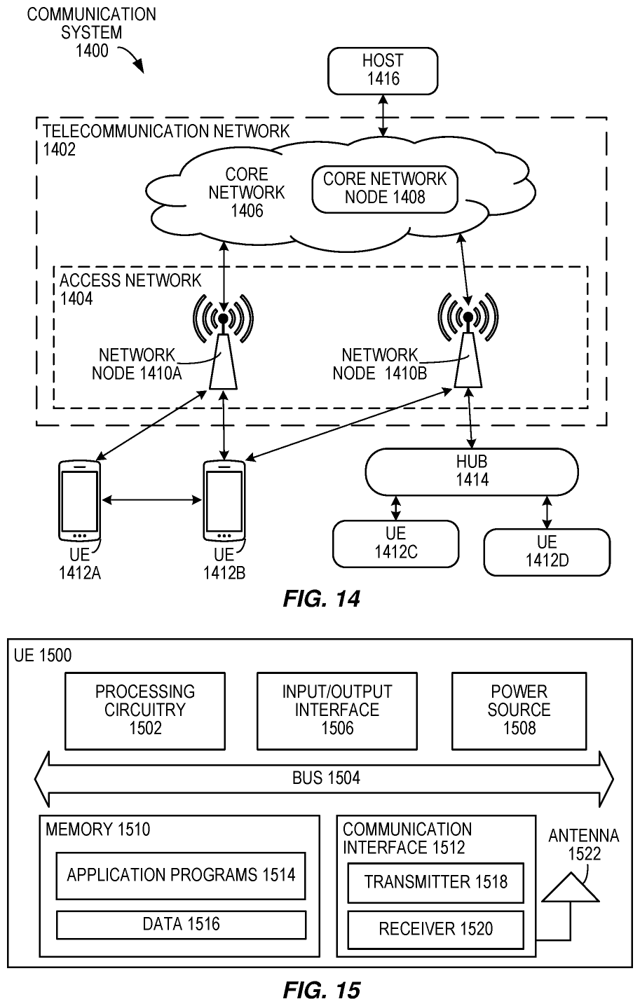

FIG. 14 shows an example of a communication system 1400 in accordance with some embodiments. In this example, communication system 1400 includes telecommunication network 1402 that includes access network 1404 (e.g., RAN) and core network 1406, which includes one or more core network nodes 1408. Access network 1404 includes one or more access network nodes, such as network nodes 1410a-b (one or more of which may be generally referred to as network nodes 1410), or any other similar 3GPP access node or non-3GPP access point. Network nodes 1410 facilitate direct or indirect connection of UEs, such as by connecting UEs 1412a-d (one or more of which may be generally referred to as UEs 1412) to core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1400 may include any number of wired or wireless networks, network nodes, UEs, and/or any other components or systems that may facilitate or participate in the communication of data and/or signals whether via wired or wireless connections. Communication system 1400 may include and/or interface with any type of communication, telecommunication, data, cellular, radio network, and/or other similar type of system.

UEs 1412 may be any of a wide variety of communication devices, including wireless devices arranged, configured, and/or operable to communicate wirelessly with network nodes 1410 and other communication devices. Similarly, network nodes 1410 are arranged, capable, configured, and/or operable to communicate directly or indirectly with UEs 1412 and/or with other network nodes or equipment in telecommunication network 1402 to enable and/or provide network access, such as wireless network access, and/or to perform other functions, such as administration in telecommunication network 1402.

In the depicted example, core network 1406 connects network nodes 1410 to one or more hosts, such as host 1416. These connections may be direct or indirect via one or more intermediary networks or devices. In other examples, network nodes may be directly coupled to hosts. Core network 1406 includes one or more core network nodes (e.g., 1408) that are structured with hardware and software components. Features of these components may be substantially similar to those described with respect to the UEs, network nodes, and/or hosts, such that the descriptions thereof are generally applicable to the corresponding components of core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1416 may be under the ownership or control of a service provider other than an operator or provider of access network 1404 and/or telecommunication network 1402, and may be operated by the service provider or on behalf of the service provider. Host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1402 is a cellular network that implements 3GPP standardized features. Accordingly, telecommunication network 1402 may support network slicing to provide different logical networks to different devices that are connected to telecommunication network 1402. For example, telecommunication network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1412 are configured to transmit and/or receive information without direct human interaction. For instance, a UE may be designed to transmit information to access network 1404 on a predetermined schedule, when triggered by an internal or external event, or in response to requests from access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1414 communicates with access network 1404 to facilitate indirect communication between one or more UEs (e.g., 1412c and/or 1412d) and network nodes (e.g., 1410b). In some examples, hub 1414 may be a controller, router, content source and analytics, or any of the other communication devices described herein regarding UEs. For example, hub 1414 may be a broadband router enabling access to core network 1406 for the UEs. As another example, hub 1414 may be a controller that sends commands or instructions to one or more actuators in the UEs. Commands or instructions may be received from the UEs, network nodes 1410, or by executable code, script, process, or other instructions in hub 1414. As another example, hub 1414 may be a data collector that acts as temporary storage for UE data and, in some embodiments, may perform analysis or other processing of the data. As another example, hub 1414 may be a content source. For example, for a UE that is a VR headset, display, loudspeaker or other media delivery device, hub 1414 may retrieve VR assets, video, audio, or other media or data related to sensory information via a network node, which hub 1414 then provides to the UE either directly, after performing local processing, and/or after adding additional local content. In still another example, hub 1414 acts as a proxy server or orchestrator for the UEs, such as if one or more of the UEs are low energy IoT devices.

Hub 1414 may have a constant/persistent or intermittent connection to network node 1410b. Hub 1414 may also allow for a different communication scheme and/or schedule between hub 1414 and UEs (e.g., 1412c and/or 1412d), and between hub 1414 and core network 1406. In other examples, hub 1414 is connected to core network 1406 and/or one or more UEs via a wired connection. Moreover, hub 1414 may be configured to connect to an M2M service provider over access network 1404 and/or to another UE over a direct connection. In some scenarios, UEs may establish a wireless connection with network nodes 1410 while still connected via hub 1414 via a wired or wireless connection. In some embodiments, hub 1414 may be a dedicated hub-that is, a hub whose primary function is to route communications to/from the UEs from/to network node 1410b. In other embodiments, hub 1414 may be a non-dedicated hub-that is, a device that can route communications between the UEs and network node 1410b, but which is additionally capable of operating as a communication start and/or end point for certain data channels.

FIG. 15 shows a UE 1500 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1500 includes processing circuitry 1502 that is operatively coupled via bus 1504 to input/output interface 1506, power source 1508, memory 1510, communication interface 1512, and optionally to one or more other components not explicitly shown. Moreover, certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

Processing circuitry 1502 is configured to process instructions and data and may be configured to implement any sequential state machine operative to execute instructions stored as machine-readable computer programs in memory 1510. Processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1502 may include multiple central processing units (CPUs).

In the example, input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1508 is structured as a battery or battery pack. Other types of power sources, such as an external power source (e.g., an electricity outlet), photovoltaic device, or power cell, may be used. Power source 1508 may further include power circuitry for delivering power from power source 1508 itself, and/or an external power source, to the various parts of UE 1500 via input circuitry or an interface such as an electrical power cable. Delivering power may be, for example, for charging power source 1508. Power circuitry may perform any formatting, converting, or other modification to the power from power source 1508 to make the power suitable for the respective components of UE 1500 to which power is supplied.

Memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1510 includes one or more application programs 1514, such as an operating system, web browser application, a widget, gadget engine, or other application, and corresponding data 1516. Memory 1510 may store, for use by UE 1500, any of a variety of various operating systems or combinations of operating systems.

Memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” Memory 1510 may allow UE 1500 to access instructions, application programs and the like, stored on transitory or non-transitory memory media, to off-load data, or to upload data. An article of manufacture, such as one utilizing a communication system may be tangibly embodied as or in memory 1510, which may be or comprise a device-readable storage medium.

Processing circuitry 1502 may be configured to communicate with an access network or other network using communication interface 1512. Communication interface 1512 may comprise one or more communication subsystems and may include or be communicatively coupled to an antenna 1522. Communication interface 1512 may include one or more transceivers used to communicate, such as by communicating with one or more remote transceivers of another device capable of wireless communication (e.g., another UE or a network node in an access network). Each transceiver may include transmitter 1518 and/or receiver 1520 appropriate to provide network communications (e.g., optical, electrical, frequency allocations, and so forth). Moreover, transmitter 1518 and/or receiver 1520 may be coupled to one or more antennas (e.g., 1522) and may share circuit components, software, or firmware, or alternatively be implemented separately.

In the illustrated embodiment, communication functions of communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.15, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1500 shown in FIG. 15.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As a specific example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the present disclosure also include, but are not limited to, the following enumerated examples.
A1. A method for a user equipment (UE) configured to operate as a relay UE for sidelink (SL) communication between a source UE and a target UE, the method comprising:
   identifying the target UE based on a SL discovery procedure performed by the UE or by the target UE;
   sending, to the target UE, a first message that includes a relay service code (RSC) indicating a UE-to-UE relay service provided by the UE;
   obtaining one or more security keys based on one of the following: a security identifier associated with the UE, a security identifier associated with the target UE, or an authorization token; and
   establishing a secure link with the target UE based on the obtained one or more security keys.
A1a. The method of embodiment A1, wherein identifying the target UE is responsive to establishing a secure link with the source UE.
A2. The method of any of embodiments A1-A1a, wherein the security identifier is one of the following: a Subscription Concealed Identifier (SUCI), or a ProSe Remote User Key identifier (PRUK ID).
A3. The method of any of embodiments A1-A2, further comprising receiving, from the target UE in response to the first message, a second message that includes the security identifier associated with the target UE.
A4. The method of embodiment A3, wherein the first message also includes address or identifier information for one or more of the following: the source UE, the target UE, and the UE.
A5. The method of any of embodiments A3-A4, wherein the first message is a direct communication invite and the second message is a direct communication request.
A6. The method of any of embodiments A3-A5, wherein obtaining one or more security keys comprises:
   sending to a 5G core network (5GC) a key request including the RSC and the security identifier received in the second message;
   receiving a key response from the 5GC; and
   deriving the one or more security keys based on the key response.

A7. The method of embodiment A6, wherein:
the second message and the key request also include a first key freshness parameter;
the key response includes a second key freshness parameter; and
establishing the secure link comprises:
   sending to the target UE a direct security mode command including the second key freshness parameter;
   receiving from the target UE a direct security mode complete message; and
   verifying the direct security mode complete message using at least one of the derived security keys.
A8. The method of any of embodiments A1-A7, wherein identifying the target UE based on the SL discovery procedure comprises obtaining indications of one or more of the following from the target UE during the SL discovery procedure:
   whether the target UE supports network-based relay service authentication and authorization over the target UE's connection with its serving network;
   whether the target UE supports network-based relay service authentication and authorization over the relay UE's connection with its serving network;
   whether the target UE supports peer UE-to-peer UE service authentication and authorization; and
   whether the target UE is in coverage of a network.
A9. The method of embodiment A8, wherein obtaining one or more security keys based on a security identifier associated with the target UE is responsive to obtaining an indication that the target UE supports network-based relay service authentication and authorization over the relay UE's connection with its serving network.
A10. The method of embodiment A8, wherein obtaining one or more security keys based on a security identifier associated with the UE is responsive to obtaining indications of one or more the following during the SL discovery procedure:
   the target UE does not support network-based relay service authentication and authorization over the relay UE's connection with its serving network;
   the target UE supports network-based relay service authentication and authorization over the target UE's connection with its serving network; and
   the target UE is in coverage of a network.
A11. The method of embodiment A10, wherein:
   the first message is a direct communication request that includes the security identifier associated with the UE and a first key freshness parameter; and
   obtaining one or more security keys based on a security identifier associated with the UE comprises:
      receiving from the target UE in response to the first message a direct security mode command including a second key freshness parameter;
      deriving the one or more security keys based on the second key freshness parameter.
A12. The method of embodiment A11, wherein deriving the one or more security keys is further based on the RSC and the security key identifier associated with the UE.
A13. The method of any of embodiments A11-A12, wherein establishing the secure link comprises:
   verifying the direct security mode command message using at least one of the derived security keys; and
   sending to the target UE a direct security mode complete message.
A14. The method of embodiment A8, wherein obtaining one or more security keys based on the authorization token is responsive to obtaining during the SL discovery procedure an indication that the target UE supports peer UE-to-peer UE service authentication and authorization.
A14a. The method of embodiment A14, wherein obtaining one or more security keys based on the authorization token is further responsive to obtaining during the SL discovery procedure indications of at least one of the following:
   the target UE does not support network-based relay service authentication and authorization over the relay UE's connection with its serving network;
   the target UE does not support network-based relay service authentication and authorization over the target UE's connection with its serving network; and
   the target UE is not in coverage of a network.
A15. The method of any of embodiments A14-A14a wherein obtaining one or more security keys based on the authorization token comprises a Direct Auth and Key Establish procedure performed with the target UE.
B1. A method for a user equipment (UE) configured to operate as a target UE for sidelink (SL) communication with a source UE via a relay UE, the method comprising:
   identifying the relay UE based on a SL discovery procedure performed by the UE or by the relay UE;
   receiving, from the relay UE, a first message that includes a relay service code (RSC) indicating a UE-to-UE relay service provided by the relay UE;
   obtaining one or more security keys based on one of the following: a security identifier associated with the relay UE, a security identifier associated with the UE, or an authorization token; and
   establishing a secure link with the relay UE based on the obtained one or more security keys.
B1a. The method of embodiment B1, wherein the SL discovery procedure is performed by the relay UE after establishing a secure link with the source UE.
B2. The method of any of embodiments B1-B2, wherein the security identifier is one of the following: a Subscription Concealed Identifier (SUCI), or a ProSe Remote User Key identifier (PRUK ID).
B3. The method of any of embodiments B1-B2, further comprising sending, to the relay UE in response to the first message, a second message that includes the security identifier associated with the UE.
B4. The method of embodiment B3, wherein the first message also includes address or identifier information for one or more of the following: the source UE, the UE, and the relay UE
B5. The method of any of embodiments B3-B4, wherein the first message is a direct communication invite and the second message is a direct communication request.
B6. The method of any of embodiments B3-B5, wherein:
   the second message also includes a first key freshness parameter; and
   obtaining one or more security keys based on a security identifier associated with the UE comprises:
      receiving from the relay UE in response to the first message a direct security mode command including a second key freshness parameter;
      deriving the one or more security keys based on the second key freshness parameter.
B7. The method of embodiment B6, wherein deriving the one or more security keys is further based on the RSC and the security key identifier associated with the UE.
B8. The method of any of embodiments B6-B7, wherein establishing the secure link comprises:
   verifying the direct security mode command using at least one of the derived security keys; and
   sending to the UE a direct security mode complete message.
B9. The method of any of embodiments B1-B8, wherein identifying the relay UE based on the SL discovery procedure comprises providing indications of one or more of the following to the relay UE during the SL discovery procedure:
   whether the UE supports network-based relay service authentication and authorization over the UE's connection with its serving network;
   whether the UE supports network-based relay service authentication and authorization over the relay UE's connection with its serving network;
   whether the UE supports peer UE-to-peer UE service authentication and authorization; and
   whether the UE is in coverage of a network.
B10. The method of embodiment B9, wherein obtaining one or more security keys based on a security identifier associated with the UE is responsive to providing an indication that the UE supports network-based relay service authentication and authorization over the relay UE's connection with its serving network.
B11. The method of embodiment B9, wherein obtaining one or more security keys based on a security identifier associated with the relay UE is responsive to providing indications of one or more of the following during the SL discovery procedure:
   the UE does not support network-based relay service authentication and authorization over the relay UE's connection with its serving network;
   the UE supports network-based relay service authentication and authorization over the UE's connection with its serving network; and
   the UE is in coverage of a network.
B12. The method of embodiment B11, wherein:
   the first message is a direct communication request that includes the security identifier associated with the relay UE and a first key freshness parameter; and
   obtaining one or more security keys comprises:
      sending to a 5G core network (5GC) a key request including the RSC and the security identifier received in the first message;
      receiving a key response from the 5GC; and
      deriving the one or more security keys based on the key response.
B13. The method of embodiment B12, wherein:
   the key response includes a second key freshness parameter; and
   establishing the secure link comprises:
      sending to the relay UE a direct security mode command including the second key freshness parameter;
      receiving from the relay UE a direct security mode complete message; and
      verifying the direct security mode complete message using at least one of the derived security keys.
B14. The method of embodiment B9, wherein obtaining one or more security keys based on the authorization token is responsive to providing during the SL discovery procedure an indication that the UE supports peer UE-to-peer UE service authentication and authorization.
B14a. The method of embodiment B14, wherein obtaining one or more security keys based on the authorization token is further responsive to providing during the SL discovery procedure indications of one or more of the following:
   the UE does not support network-based relay service authentication and authorization over the relay UE's connection with its serving network;
   the UE does not support network-based relay service authentication and authorization over the UE's connection with its serving network; and
   the UE is not in coverage of a network.
B15. The method of any of embodiments B14-B14a, wherein obtaining one or more security keys based on the authorization token comprises a Direct Auth and Key Establish procedure performed with the relay UE.
C1. A user equipment (UE) configured to operate as a relay UE for sidelink (SL) communication between a source UE and a target UE, the UE comprising:
   communication interface circuitry configured to communicate with the source UE and the target UE; and
   processing circuitry operatively coupled to the communication interface circuitry, whereby the processing circuitry and the communication interface circuitry are configured to perform operations corresponding to any of the methods of embodiments A1-A15.
C2. A user equipment (UE) configured to operate as a relay UE for sidelink (SL) communication between a source UE and a target UE, the UE being further configured to perform operations corresponding to any of the methods of embodiments A1-A15.
C3. A non-transitory, computer-readable medium storing computer-executable instructions that, when executed by processing circuitry of a user equipment (UE) configured to operate as a relay UE for sidelink (SL) communication between a source UE and a target UE, configure the UE to perform operations corresponding to any of the methods of embodiments A1-A15.
C4. A computer program product comprising computer-executable instructions that, when executed by processing circuitry of a user equipment (UE) configured to operate as a relay UE for sidelink (SL) communication between a source UE and a target UE, configure the UE to perform operations corresponding to any of the methods of embodiments A1-A15.
D1. A user equipment (UE) configured to operate as a target UE for sidelink (SL) communication with a source UE via a relay UE, the UE comprising:
   communication interface circuitry configured to communicate with the relay UE and with a wireless network; and
   processing circuitry operatively coupled to the communication interface circuitry, whereby the processing circuitry and the communication interface circuitry are configured to perform operations corresponding to any of the methods of embodiments B1-B15.
D2. A user equipment (UE) configured to operate as a target UE for sidelink (SL) communication with a source UE via a relay UE, the UE being further configured to perform operations corresponding to any of the methods of embodiments B1-B15.
D3. A non-transitory, computer-readable medium storing computer-executable instructions that, when executed by processing circuitry of a user equipment (UE) configured to operate as a target UE for sidelink (SL) communication with a source UE via a relay UE, configure the UE to perform operations corresponding to any of the methods of embodiments B1-B15.
D4. A computer program product comprising computer-executable instructions that, when executed by processing circuitry of a user equipment (UE) configured to operate as a target UE for sidelink (SL) communication with a source UE via a relay UE, configure the UE to perform operations corresponding to any of the methods of embodiments B1-B15.

1.-33. (canceled)

34. A method for a user equipment (UE) configured to operate as a relay UE for sidelink (SL) communication between a source UE and a target UE, the method comprising:
identifying the target UE based on a SL discovery procedure performed by the UE or by the target UE;
sending, to the target UE, a first message that includes a relay service code (RSC) that indicates a UE-to-UE relay service provided by the UE;
obtaining one or more security keys based on a security identifier associated with the target UE; and
establishing a secure link with the target UE based on the obtained one or more security keys.

35. The method of claim 34, wherein identifying the target UE is responsive to establishing the secure link with the source UE.

36. The method of claim 34, wherein the security identifier is one of the following: a Subscription Concealed Identifier (SUCI), or a ProSe Remote User Key identifier (PRUK ID).

37. The method of claim 34, further comprising receiving, from the target UE in response to the first message, a second message that includes the security identifier associated with the target UE.

38. The method of claim 37, wherein the first message also includes address or identifier information for one or more of the following: the source UE, the target UE, and the UE.

39. The method of claim 37, wherein the first message is a direct communication invite and the second message is a direct communication request.

40. The method of claim 37, wherein obtaining one or more security keys comprises:
sending, to a communication network, a key request including the RSC and the security identifier received in the second message;
receiving a key response from the communication network; and
deriving the one or more security keys based on the key response.

41. The method of claim 40, wherein:
the second message and the key request also include a first key freshness parameter;
the key response includes a second key freshness parameter; and
establishing a secure link with the target UE comprises:
sending to the target UE a direct security mode command including the second key freshness parameter;
receiving from the target UE a direct security mode complete message; and
verifying the direct security mode complete message using at least one of the derived security keys.

42. A method for a user equipment (UE) configured to operate as a target UE for sidelink (SL) communication with a source UE via a relay UE, the method comprising:
identifying the relay UE based on a SL discovery procedure performed by the UE or by the relay UE;
receiving, from the relay UE, a first message that includes a relay service code (RSC) that indicates a UE-to-UE relay service provided by the relay UE;
obtaining one or more security keys based on a security identifier associated with the UE; and
establishing a secure link with the relay UE based on the obtained one or more security keys.

43. The method of claim 42, wherein the SL discovery procedure is performed by the relay UE after the relay UE establishes a secure link with the source UE.

44. The method of claim 42, wherein the security identifier is one of the following: a Subscription Concealed Identifier (SUCI), or a ProSe Remote User Key identifier (PRUK ID).

45. The method of claim 42, further comprising sending, to the relay UE in response to the first message, a second message that includes the security identifier associated with the UE.

46. The method of claim 45, wherein the first message also includes address or identifier information for one or more of the following: the source UE, the UE, and the relay UE.

47. The method of claim 45, wherein the first message is a direct communication invite and the second message is a direct communication request.

48. The method of claim 45, wherein the second message also includes a first key freshness parameter, and obtaining one or more security keys based on a security identifier associated with the UE comprises:
receiving, from the relay UE in response to the first message, a direct security mode command including a second key freshness parameter; and
deriving the one or more security keys based on the second key freshness parameter.

49. The method of claim 48, wherein deriving the one or more security keys is further based on the RSC and the security key identifier associated with the UE.

50. The method of claim 48, wherein establishing the secure link with the relay UE comprises:
verifying the direct security mode command using at least one of the derived security keys; and
sending to the UE a direct security mode complete message.

51. User equipment (UE) configured to operate as a relay UE for sidelink (SL) communication between a source UE and a target UE, the UE comprising:
communication interface circuitry configured to communicate with at least the source UE and the target UE; and
processing circuitry operatively coupled to the communication interface circuitry, wherein the processing circuitry and the communication interface circuitry are configured to:
identify the target UE based on a SL discovery procedure performed by the UE or by the target UE;
send, to the target UE, a first message that includes a relay service code (RSC) that indicates a UE-to-UE relay service provided by the UE;
obtain one or more security keys based on a security identifier associated with the target UE; and
establish a secure link with the target UE based on the obtained one or more security keys.

52. The UE of claim 51, wherein:
the processing circuitry and the communication interface circuitry are further configured to receive, from the target UE in response to the first message, a second message that includes the security identifier associated with the target UE; and
one or more of the following applies:
the first message also includes address or identifier information for one or more of the following: the source UE, the target UE, and the UE;
the first message is a direct communication invite; and
the second message is a direct communication request.

53. User equipment (UE) configured to operate as a target UE for sidelink (SL) communication with a source UE via a relay UE, the UE comprising:
communication interface circuitry configured to communicate with the relay UE; and
processing circuitry operatively coupled to the communication interface circuitry, wherein the processing circuitry and the communication interface circuitry are configured to perform the method of claim 42.

54. The UE of claim 53, wherein:
the processing circuitry and the communication interface circuitry are further configured to send, to the relay UE in response to the first message, a second message that includes the security identifier associated with the target UE; and
one or more of the following applies:
the first message also includes address or identifier information for one or more of the following: the source UE, the target UE, and the UE;
the first message is a direct communication invite; and
the second message is a direct communication request.
